(19) United States
(12) Patent Application Publication
(10) Pub. No.: US 2008/0244638 A1
(43) Pub. Date: Oct. 2, 2008

(54) Selection and output of advertisements using subtitle data

(75) Inventor: Darren Ryden, Newbury (GB)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/731,437

(22) Filed: Mar. 30, 2007

(51) Int. Cl. H04N 7/04

(52) U.S. Cl. 725/34

(57) ABSTRACT

Techniques are described to select and output advertisements based on subtitles. In an implementation, one or more keywords are received that are extracted from subtitle data. One or more advertisements are selected based on the one or more keywords.

### BACKGROUND

Advertising continues to be one of the major driving factors used to generate revenue by content providers and network operators. In traditional advertising models, advertisements were included in content, such as television programs, which were then broadcast “over the air” to consumers such that the consumers were able to consume the content. However, the ways in which a user may obtain and interact with content continues to expand, which is not addressed by these traditional advertising models.

Users, for example, may have access to content from a variety of sources and further may interact with that content as desired. For instance, a user may use digital cable to receive television programs, purchase movies, request video-on-demand, and so on. In another instance, the user may use digital video recorder (DVR) functionality to record desired content and output it when desired and thereby “time shift” an output of the content. The user may also use DVR functionality to time shift the content as it is being output, such as to fast forward through portions of the content, pause an output of the content, and so on. The traditional advertising models, however, did not address this added functionality, thereby limiting the opportunities of advertisers to promote their goods or services.

### SUMMARY

Techniques are described to select and output advertisements based on subtitle data. In an implementation, one or more keywords are received that are extracted from subtitle data. One or more advertisements are selected based on the one or more keywords.

In another implementation, one or more keywords are detected in subtitle data that is associated with content. Output is caused of one or more advertisements in conjunction with the content, wherein the one or more advertisements correspond to the one or more keywords

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an exemplary implementation that is operable to select advertisements and cause output of the advertisements based on subtitle data.

FIG. 2 is an illustration of a system showing a network operator and a client of FIG. 1 in greater detail.

FIG. 3 is a flow diagram depicting a procedure in an exemplary implementation in which keywords are extracted from subtitle data and used to select one or more advertisements.

FIG. 4 is a flow diagram depicting a procedure in an exemplary implementation in which detection of one or more keywords in subtitle data that is associated with content is used to cause output of one or more advertisements in conjunction with the content.

FIG. 5 is a flow diagram depicting a procedure in an exemplary implementation in which subtitle data received via an out-of-band network connection is used to select advertisements and cause output of the advertisements at a client.

### DETAILED DESCRIPTION

Overview

Users have access to an increasing range of content and techniques that may be used to consume that content, such as video-on-demand, digital video recorders, digital television systems that offer interactive programming, and so on. Traditional advertising models, however, did not address this increasing functionality and further may even be hampered by this increased functionality, such as to skip television advertisements in traditional broadcast content using a digital video recorder (DVR).

Techniques are described in which advertisements are selected and/or caused to be output based on subtitle data. Subtitle data is typically configured as a textual representation of spoken audio and other sounds in content, such as a television program. For example, the subtitle data may provide closed-captioning data that is used to provide a textual description of audio in a television program, such as spoken words as well as brief descriptions of other sounds that are also typically heard in the corresponding television program, e.g., a notification of the sound of a breaking glass. Subtitle data may also be used with foreign languages, such as to provide a translation from one language to another. Thus, the subtitle data may provide a rich resource which describes associated content (e.g., the television program) which may be leveraged to provide a wide variety of functionality.

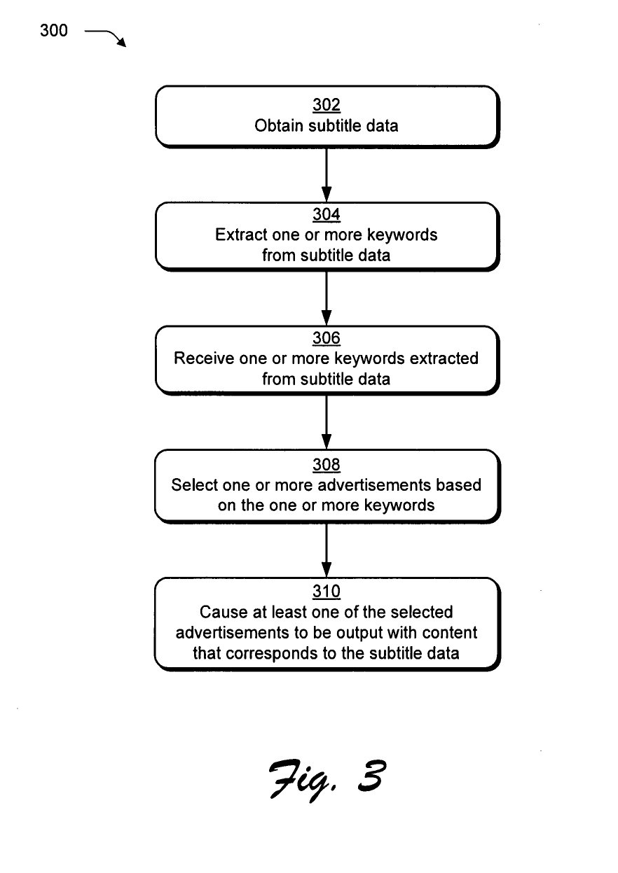

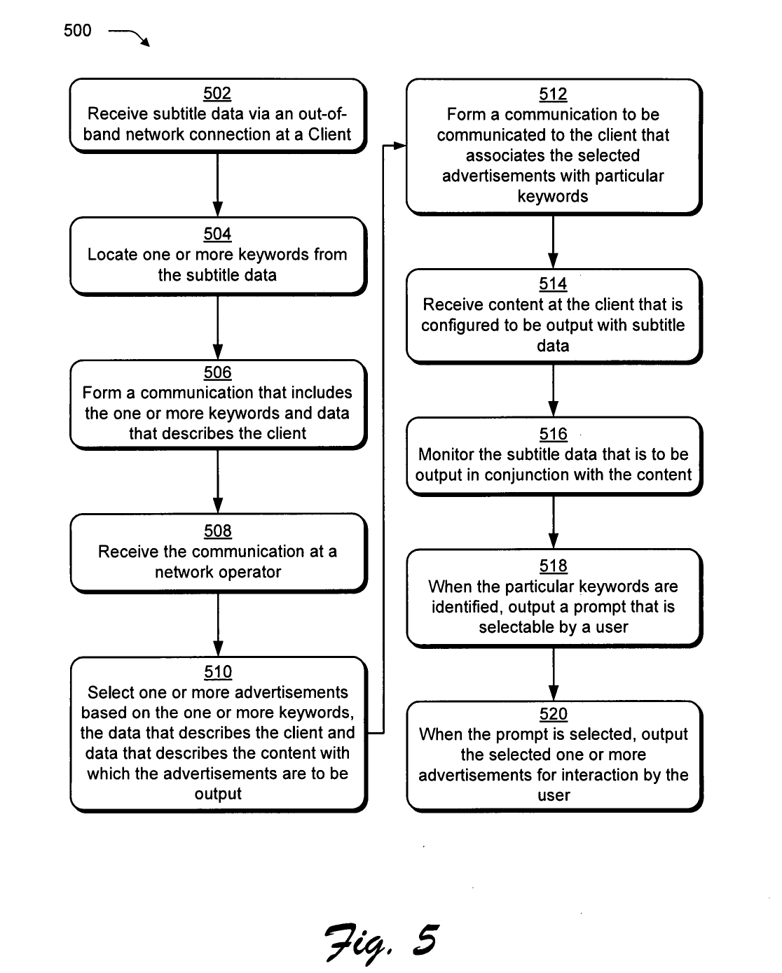

In an implementation, the subtitle data is leveraged to select advertisements to be output in conjunction with the content. For example, the subtitle data may be examined to locate particular keywords, which are then utilized to select advertisements. In this way, the keywords provide a description of a context of the content such that advertisements may be selected to coincide with this context. For instance, a car show may include multiple keywords that reference cars, particular brands of cars and even particular makes of the cars. These keywords may then be used to select advertisements to be output in conjunction with this content, such as to show a car advertisement, car advertisements from particular manufacturers and even car advertisements for the particular make of car. Thus, the selected advertisements may be targeted for the users based on the subtitle data, further discussion of which may be found in relation to FIGS. 3 and 5.

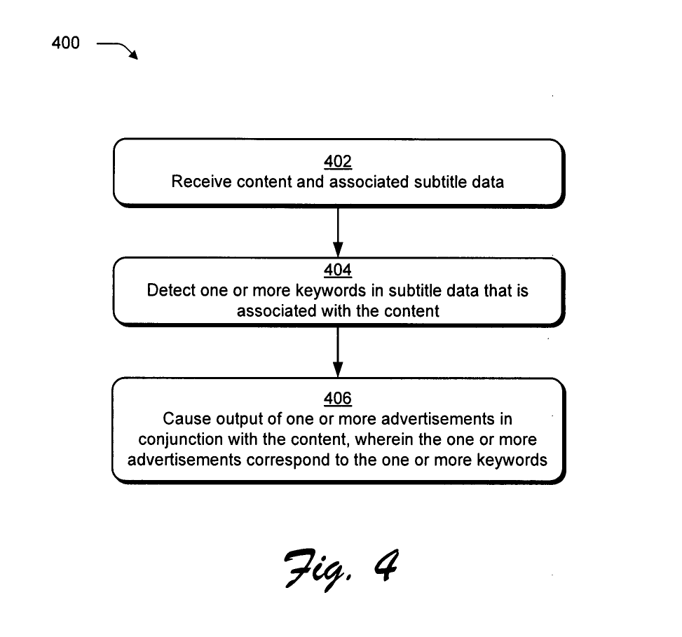

In another implementation, the subtitle data is leveraged to select when to output a particular advertisement. As previously described, the users have access to devices which may be used to “time shift” content, such as through use of a DVR, video-on-demand, and so on. Accordingly, in this implementation a determination of “when” to output an advertisement may be made based on the subtitle data, such as by monitoring the subtitle data for a particular combination of keywords. Thus, regardless of whether the content was time shifted, the advertisement may still be output as intended. Further discussion of the leveraging of subtitle data to select when to output an advertisement may be found in relation to FIGS. 4 and 5.

In the following discussion, an exemplary environment is first described that is operable to perform techniques to select and/or output advertisements based on subtitle data. Exemplary procedures are then described that may be employed in the exemplary environment, as well as in other environments. Although these techniques are described as employed within a television environment in the following discussion, it should be readily apparent that these techniques may be incorporated within a variety of environments without departing from the spirit and scope thereof.

Exemplary Environment

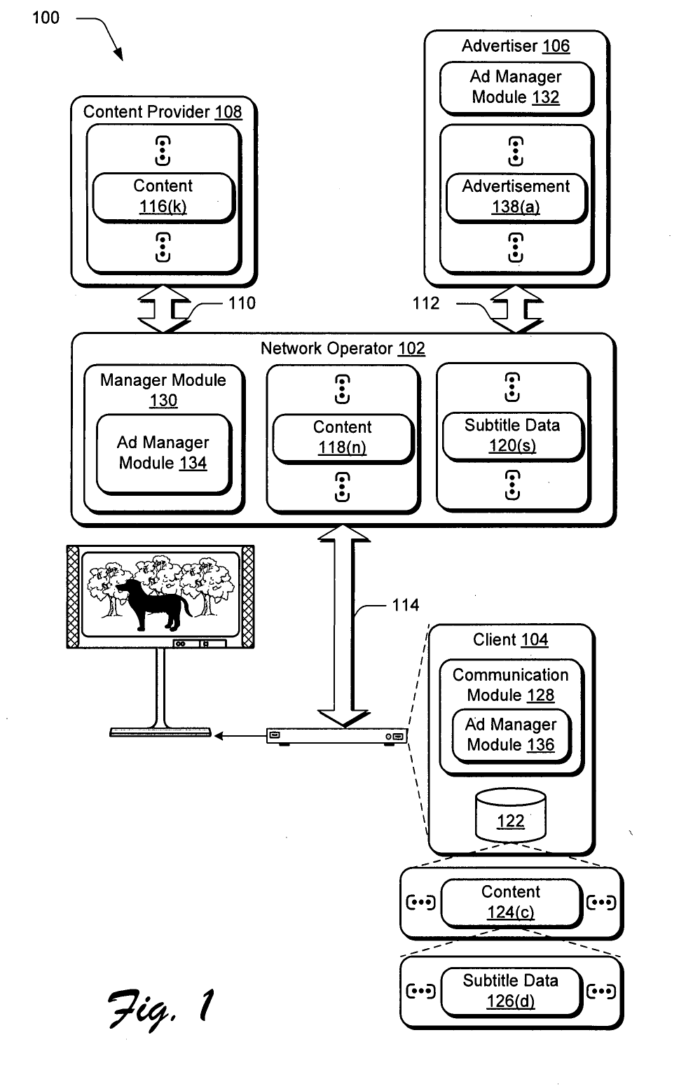

FIG. 1 is an illustration of an environment 100 in an exemplary implementation that is operable to select advertisements and cause output of the advertisements based on subtitle data. The illustrated environment 100 includes a network operator 102 (e.g., a “head end”), a client 104, an advertiser 106 and a content provider 108 that are communicatively coupled, one to another, via network connections 110, 112, 114. In the following discussion, the network operator 102, the client 104, the advertiser 106 and the content provider 108 may be representative of one or more entities, and therefore reference may be made to a single entity (e.g., the client 104) or multiple entities (e.g., the clients 104, the plurality of clients 104, and so on). Additionally, although a plurality of network connections 110-114 are shown separately, the network connections 110-114 may be representative of network connections achieved using a single network or multiple networks. For example, network connection 114 may be representative of a broadcast network with back channel communication, an Internet Protocol (IP) network, and so on.

The client 104 may be configured in a variety of ways. For example, the client 104 may be configured as a computer that is capable of communicating over the network connection 114, such as a desktop computer, a mobile station, an entertainment appliance, a set-top box communicatively coupled to a display device as illustrated, a wireless phone, and so forth. Thus, the client 104 may range from a full resource device with substantial memory and processor resources (e.g., television-enabled personal computers, television recorders equipped with hard disk) to a low-resource device with limited memory and/or processing resources (e.g., traditional set-top boxes). For purposes of the following discussion, the client 104 may also relate to a person and/or entity that operate the client. In other words, client 104 may describe a logical client that includes a user, software and/or a machine.

The content provider 108 includes one or more items of content 116(k), where “k” can be any integer from 1 to “K”. The content 116(k) may include a variety of data, such as television programming, video-on-demand (VOD) files, one or more results of remote application processing, and so on. The content 116(k) is communicated over the network connection 110 to the network operator 102.

Content 116(k) communicated via the network connection 110 is received by the network operator 102 and may be stored as one or more items of content 118(n), where “n” can be any integer from “1” to “N”. The content 118(n) may be the same as or different from the content 116(k) received from the content provider 108. The content 118(n), for instance, may include additional data for broadcast to the client 104. For example, the content 11 8(n) may include electronic program guide (EPG) data from an EPG database for broadcast to the client 104 utilizing a carousel file system. The carousel file system repeatedly broadcasts the EPG data over an out-of-band (OOB) channel to the client 104 over the network connection 114. Distribution from the network operator 102 to the client 104 may be accommodated in a number of ways, including cable, radio frequency (RF), microwave, digital subscriber line (DSL), and satellite.

The content 118(n) may also be associated with subtitle data 120(s), where “s” can be any integer from one to “S”. As previously described, subtitle data 120(s) may be configured in a variety of ways, such as a textual representation of spoken audio and other sounds in content, such as a television program. For example, the subtitle data 120(s) may provide closed-captioning data that is used to provide a textual description of audio in a television program, such as spoken words as well as brief descriptions of other sounds that are also typically heard in the corresponding television program, e.g., a notification of the sound of a breaking glass. Subtitle data 120(s) may also be used with foreign languages, such as to provide a translation from one language to another. The network operator 102 may provide the subtitle data 120(s) to the client 104 in a variety of ways, such as through streaming “with” the content 118(n) over the network connection 114, before the content 118(n) is streamed, and so on using any one of the previously described communication techniques.

The client 104, as previously stated, may be configured in a variety of ways to receive the content 118(n) over the network connection 114. The client 104 typically includes hardware and software to transport and decrypt content 118(n) received from the network operator 102 for rendering by the illustrated display device. Although a display device is shown, a variety of other output devices are also contemplated, such as speakers.

The client 104 may also include digital video recorder (DVR) functionality. For instance, the client 104 may include a storage device 122 to record content 118(n) as content 124(c) (where “c” can be any integer from one to “C”) received via the network connection 114 for output to and rendering by the display device. The storage device 122 may be configured in a variety of ways, such as a hard disk drive, a removable computer-readable medium (e.g., a writable digital video disc), and so on. Thus, content 124(c) that is stored in the storage device 122 of the client 104 may be copies of the content 118(n) that was streamed from the network operator 102. Additionally, content 124(c) may be obtained from a variety of other sources, such as from a computer-readable medium that is accessed by the client 104, and so on. Further, the content 124(c) may also include subtitle data 126(d), which may be the same as or different from subtitle data 120(s).

The client 104 includes a communication module 128 that is executable on the client 104 to control content playback on the client 104, such as through the use of one or more “command modes”. The command modes may provide non-linear playback of the content 124(c) (i.e., time shift the playback of the content 124(c)) such as pause, rewind, fast forward, slow motion playback, and the like. For example, during a pause, the client 104 may continue to record the content 118(n) in the storage device 122 as content 124(c). The client 104, through execution of the communication module 128, may then playback the content 124(c) from the storage device 122, starting at the point in time the content 124(c) was paused, while continuing to record the currently-broadcast content 118(n) in the storage device 122 from the network operator 102.

The network operator 102 is illustrated as including a manager module 130. The manager module 130 is representative of functionality to configure content 118(n) for output (e.g., streaming) over the network connection 114 to the client 104. The manager module 130, for instance, may configure content 116(k) received from the content provider 108 to be suitable for transmission over the network connection 114, such as to “packetize” the content for distribution over the Internet, configuration for a particular broadcast channel, map the content 116(k) to particular channels, and so on.

Thus, in the environment 100 of FIG. 1, the content provider 108 may broadcast the content 116(k) over a network connection 110 to a multiplicity of network operators, an example of which is illustrated as network operator 102. The network operator 102 may then stream the content 118(n) over a network connection to a multitude of clients, an example of which is illustrated as client 104. The client 104 may then store the content 118(n) in the storage device 122 as content 124(c), such as when the client 104 is configured to include digital video recorder (DVR) functionality.

The content 118(n) may also be representative of time-shifted content, such as video-on-demand (VOD) content that is streamed to the client 104 when requested, such as movies, sporting events, and so on. For example, the network operator 102 may execute the manager module 130 to provide a VOD system such that the content provider 108 supplies content 116(k) in the form of complete content files to the network operator 102. The network operator 102 may then store the content 116(k) as content 118(n). The client 104 may then request playback of desired content 118(n) by contacting the network operator 102 (e.g., a VOD server) and requesting a feed of the desired content.

In another example, the content 118(n) may further be representative of content (e.g., content 116(k)) that was recorded by the network operator 102 in response to a request from the client 104, in what may be referred to as a network DVR example. Like VOD, the recorded content 118(n) may then be streamed to the client 104 when requested. Interaction with the content 118(n) by the client 104 may be similar to interaction that may be performed when the content 124(c) is stored locally in the storage device 122.

The advertiser 106, the network operator 102 and the client 104 are each illustrated as including a respective ad manager module 132, 134 and 136. The ad manager modules 132, 134 and 136 are representative of functionality that may be used to select and/or output advertisements based on subtitle data. The ad manager modules 132, 134 and 136 are illustrated throughout the environment 100 to depict that the functionality incorporated therein may also be implemented through the environment 100 alone or in part. types and combinations of memory may be employed, such as random access memory (RAM), hard disk memory, removable medium memory, and other types of computer-readable media.

As previously described, the functionality of selecting and/or causing output of advertisements based on subtitle data may be distributed in the environment 100 of FIG. 1 in a variety of ways. For example, the network operator 102 may execute the manager module 130 on the processor 202, which is storable in memory 206, to stream content 118(n) to the client 104.

The client 104 may execute the communication module 128 on the processor 204, which is also storable in memory 208, to receive and manage the content 118(n). For instance, the ad manager module 136 may cause subtitle data 126(d) to be taken from the content 118(n) and stored in memory 208. The ad manager module 136 may also locate one or more keywords 210(k) (where “k” can be any integer from one to “K”) from the subtitle data 126(d), such as by locating descriptive words in the subtitle data 126(d). The ad manager module 136 may then form a backchannel communication 212 which includes these located keywords 210(k) to be communicated back to the network operator 102.

The network operator 102, upon receipt of the backchannel communication 212, may then locate advertisements, such as by matching the keywords 210(k) located in the subtitle data 126(d) with one or more keywords 214(e) specified for the advertisements 138(a). For example, the keywords 214(e) may be specified by the advertiser 106 to correlate as desired such that

The ad manager modules 132, 134, 136, for instance, may be executed to select advertisements 138(a) based on subtitle data, e.g., subtitle data 120(s), 126(d). The ad manager modules 132, 134, 136 may then cause the selected advertisements 138(a) to be output (e.g., at the client 104), such as through identification of a particular keyword or combination of keywords in the subtitle data 120(s), 126(d), further discussion of which may be found in relation to the following figure. It should be noted that one or more of the entities shown in FIG. 1 may be further divided (e.g., the network operator 102 may be implemented by a plurality of servers in a distributed computing system), combined (e.g., the network operator 102 and the advertiser 106 may be combined), and so on and thus the environment 100 of FIG. 1 is illustrative of one of a plurality of different environments that may employ the described techniques.

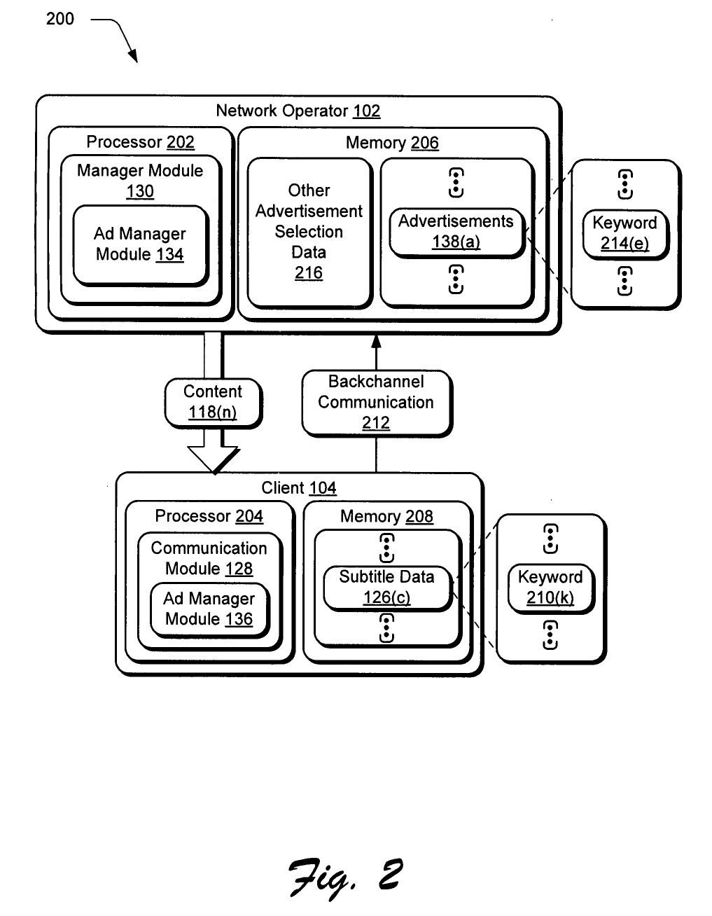

FIG. 2 depicts a system 200 in an exemplary implementation showing the network operator 102 and the client 104 in greater detail. The network operator 102 and the client 104 are both illustrated as devices having respective processors 202, 204 and memory 206, 208. Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Additionally, although a single memory 206, 208 is shown, respectively, for the network operator 102 and the client 104, a wide variety of particular advertisements 138(a) are selected for particular keywords 210(k). The ad manager module 134 may then cause the output of the advertisements 138(a) that were selected, such as to stream the advertisements 138(a) to the client 104 for immediate output and/or local storage, provide a network address of where the client 104 may obtain the advertisements (e.g., a network address of the advertiser of FIG. 1), and so on.

The ad manager module 134 may also use other advertisement selection data 216 when selecting an advertisement in addition to the keywords 210(k). For example, the other advertisement selection data 216 may include data that describes the client 104 that is to output the advertisements 138(a), such as hardware, software or network resources of the client 104, data pertaining to a user of the client 104 (e.g., demographic information and past viewing habits), and so forth. In another example, the other advertisement selection data 216 may describe a context in which the advertisement is to be output, such as to describe the content 118(n) (e.g., genre, actors, title, plot), time of day, advertising schedules, and so forth. Thus, the ad manager module 134 may take into account a variety of considerations when selecting an advertisement 138(a), further discussion of which may be found in relation to FIG. 5.

Further, the ad manager module 134 may also provide an indication of “when” to output the advertisements 138(a), such as when a particular keyword 210(k) or combination of keywords 210(k) is monitored as being output in conjunction with the content 118(n). Thus, even when the content 118(n) is time shifted, the advertisements 138(a) may be output as desired, further discussion of which may be found in relation to FIGS. 4 and 5.

Generally, any of the functions described herein can be implemented using software, firmware, hardware (e.g., fixed-logic circuitry), manual processing, or a combination of these implementations. The terms “module”, “functionality” and “logic” as used herein generally represent software, firmware, hardware, or a combination thereof. In the case of a software implementation, for instance, the module, functionality, or logic represents program code that performs specified tasks when executed on a processor (e.g., CPU or CPUs). The program code can be stored in one or more computer-readable memory devices. The features of the techniques to select and/or output advertisements using subtitle data are platform-independent, meaning that the techniques may be implemented on a variety of commercial computing platforms having a variety of processors.

Exemplary Procedures

The following discussion describes subtitle data techniques that may be implemented utilizing the previously described environment, systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the system 200 of FIG. 2.

FIG. 3 depicts a procedure 300 in an exemplary implementation in which keywords are extracted from subtitle data and used to select one or more advertisements. Subtitle data is obtained (block 302), which may be performed in a variety of ways. For example, the client 104 may receive a download of the subtitle data 126(d) before content 118(n) that corresponds to the subtitle data 126(d) is received. In another example, the content 124(c) and the subtitle data 126(d) may be received as streamed together over the network connection 114. A variety of other examples are also contemplated.

One or more keywords are extracted from subtitle data (block 304). The ad manager module 136, for instance, may employ one or more techniques to identify descriptive words in the subtitle data 126(d) or other potential words of interest. For instance, the ad manager module 136 may compare keywords 210(k) with a dictionary of keywords to locate and/or exclude particular words. A variety of other instances are also contemplated.

One or more keywords are received that are extracted from subtitle data (block 306). For example, the network operator 102 may receive the keywords 210(k) via a backchannel communication 212.

One or more advertisements are selected based on the one or more keywords (block 308). The ad manager module 134, for instance, may compare the keywords 210(k) in the backchannel communication 212 that were taken from the subtitle data 126(d) with keywords 214(e) specified for the advertisements 138(a). A variety of algorithms may be employed, such as based on a number of occurrences of particular keywords 210(k) in the subtitle data 126(d), weightings specified for particular keywords 214(e) to compute a “score”, and so on.

At least one of the selected advertised are caused to be output with content that corresponds to the subtitle data (block 310). The ad manager module 134, for instance, may form a communication to be sent to the client over the network connection 114 which indicates “how” the client 104 is to output the selected advertisements 138(a). For example, the communication may specify a network address of the advertiser 106 such that the client 104 may request the advertisements 138(a). In another example, the advertisements 138(a) may be streamed with the content 118(n) to the client 104. In a further example, the client 104 may be told “when” to output the advertisements 138(a) based on one or more of the keywords, further discussion of which may be found in relation to the following figure.

FIG. 4 depicts a procedure 400 in an exemplary implementation in which detection of one or more keywords in subtitle data that is associated with content is used to cause output of one or more advertisements in conjunction with the content. Content and associated subtitle data are received (block 402). The client 104, for instance, may receive content 118(n) that is streamed with subtitle data 120(s). In another instance, the subtitle data 120(s) may be received before the content 118(n), such as through download of a file from the network operator 102. In a further instance, the subtitle data 126(d) and the content 124(c) are received from storage 122 that is local to the client 104, such as content 124(c) and subtitle data 126(d) that was previously recorded but not output. A variety of other examples are also contemplated.

One or more keywords are detected in subtitle data that is associated with the content (block 404). The ad manager module 136, for instance, may monitor the subtitle data that coincides with the content 124(c) as it is output by the client 104 through execution of the communication module 128. For example, the ad manager module 136 may look for a particular keyword or group of keywords and cause an output of advertisements 138(a) based on detection of those one or more keywords.

It should be noted that this monitoring may be performed regardless of whether the subtitle data 126(d) is actually output and/or displayed on a display device. In other words, the subtitle data 126(d) need not be displayed on a display device for such monitoring to occur, but rather the subtitle data 126(d) that is to be output may be monitored. A variety of other examples are also contemplated.

An output is caused of one or more advertisements in conjunction with the content, wherein the one or more advertisements correspond to the one or more keywords (block 406). A variety of advertisements may be output, such as to output a prompt concurrently with the content 124(c) that, when selected by a user, causes an interactive advertisement to be output. In another example, the advertisements 138(a) may be output before, after or concurrently with the content 118(n), such as through a “ticker”, during an ad avail, and so on. Further discussion of selection and output of advertisements may be found in relation to the following figure.

FIG. 5 depicts a procedure 500 in an exemplary implementation in which subtitle data received via an out-of-band network connection is used to select advertisements and cause output of the advertisements at a client. Subtitle data is received via an out-of-band network connection at a client (block 502). For example, the out-of-band network connection may be included as a separate band and/or channel in the network connection 114 from that used to communicate the content 118(n).

One or more keywords are located from the subtitle data (block 504), such as be locating descriptive words using a variety of techniques as previously described.

A communication is then formed that includes the one or more keywords and data that described the client (block 506). The data, for instance, may describe viewing preferences that were observed by the communication module 128, demographic but not personally identifiable information of a user of the client 104, hardware, software and/or network capabilities of the client 104 (e.g., high-definition video capable), and so on.

The communication is received at the network operator (block 508). The network operator may then select one or more advertisements based on the one or more keywords, the data that describes the client and data that describes the content with which the advertisements are to be output (block 510). The data that describes the content 124(c), for instance, may describe a genre of the content 124(c), author, actors, time of day the content 124(c) is to be output, day of week the content 124(c) is to be output, and so on. A variety of other data may also be used to select advertisement 138(a), such as type of ad avail, position in an ad avail, number of times the advertisements 138(a) have been previously output by the client 104, and so on.

A communication is formed to be communicated to the client that associates the selected advertisements with particular keywords (block 512). The communication, for instance, may specify that a prompt to an interactive advertisement for a particular car is to be output when the name(s) of the particular car is detected.

Content is received at the client that is configured to be output with subtitle data (block 514). For example, the client 104 may receive content 124(c) from storage 122 (e.g., a hard disk drive such as in a DVR, from a computer-readable medium such as a digital video disc (DVD), and so on), content 118(n) streamed over a network, and so forth.

The subtitle data is monitored that is to be output in conjunction with the content (block 516). As previously described, it should be noted that the subtitle data does not need to be displayed to be monitored, but rather the subtitle data that “could” be displayed is monitored.

When the particular keywords are identified, a prompt is output that is selectable by a user (block 518). The prompt, for instance, may be output in conjunction with the content this is selectable by a user via a remote control, cursor control device and so on. When the prompt is selected, the one or more advertisements that were selected (e.g., block 510) are output for interaction by the user (block 520). For example, the advertisements may be configured to receive inputs from the user to further the user's experience with the advertisements. These advertisements may be output concurrently with an output of the content 124(c) or during a “pause” in the output of the content. A variety of other examples are also contemplated, such as display of traditional advertisements during a subsequent ad avail that were selected based on keywords encountered since a previous ad avail.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
receiving one or more keywords extracted from subtitle data; and
selecting one or more advertisements based on the one or more keywords.

2. A method as described in claim 1, wherein the subtitle data is associated with content in a broadcast.

3. A method as described in claim 1, wherein the subtitle data is associated with time-shifted content.

4. A method as described in claim 2, wherein the time-shifted content is stored locally at a client that extracted the one or more keywords.

5. A method as described in claim 1, wherein the selecting is further based on other advertisement selection data that includes data that describes a client that is to output the one or more advertisements.

6. A method as described in claim 1, wherein the selecting is further based on other advertisement selection data that includes data that describes content that is associated with the subtitle data.

7. A method as described in claim 1, further comprising forming a communication that is configured to be communicated over a network and to cause a client to output the selected one or more advertisements.

8. A method as described in claim 7, wherein the communication references one or more particular keywords that, when identified in subtitle data that is to be output in conjunction with content causes the client to output the one or more advertisements.

9. A method as described in claim 8, wherein the client is configured to output the one or more advertisements without outputting the subtitle data.

10. A method as described in claim 1, wherein at least one said advertisement includes a prompt that is:
displayable in conjunction with content; and
selectable to cause output of an interactive advertisement.

11. A method comprising:
detecting one or more keywords in subtitle data that is associated with content; and
causing output of one or more advertisements in conjunction with the content, wherein the one or more advertisements correspond to the one or more keywords.

12. A method as described in claim 11, wherein the causing is performed:
before the content is output;
at a pause in an output of the content;
concurrently during output of the content; or
after output of the content.

13. A method as described in claim 11, wherein the causing is performed without displaying the subtitle data.

14. A method as described in claim 11, wherein the detecting is performed for a particular combination of a plurality of said keywords.

15. A method as described in claim 11, wherein the detecting is performed in real time during output of the content.

16. A client comprising:
a processor; and
memory configured to maintain a module that is executable on the processor to extract keywords from subtitle data that are usable to select advertisements to be output in conjunction with content that corresponds to the subtitle data.

17. A client as described in claim 16, wherein the module is configured to retrieve the content from the memory local to the client.

18. A client as described in claim 16, wherein the module is configured to retrieve the content via a network connection.

19. A client as described in claim 16, wherein the memory is further configured to maintain the advertisements.

20. A client as described in claim 16, wherein the module is configured to extract the keywords from the subtitle data in real time as the subtitle data is streamed to the client.
